(19) United States
(12) Patent Application Publication
(10) Pub. No.: US 2005/0098993 A1
(43) Pub. Date: May 12, 2005

(54) Airbag device

(75) Inventor: Shinzo Matsumura, Echi-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/981,444

(22) Filed: Nov. 5, 2004

Related U.S. Application Data
(60) Provisional application No. 60/517,914, filed on Nov. 7, 2003.

(51) Int. Cl. B60R 21/16

(52) U.S. Cl. 280/743.1

(57) ABSTRACT

An airbag device in which the optimum conditions of the airbag are set so the airbag device can fully protect an occupant while being able to be mounted in a vehicle more efficiently. The airbag device includes an airbag which is normally stored and configured to be inflated and deployed toward an occupant in the event of a vehicle emergency. The ratio of the volume of the airbag when packaged to the volume of the airbag when inflated is at least approximately 1:30.

This application claims the benefit of Provisional Application No. 60/517,914, filed Nov. 7, 2003

### BACKGROUND

The present invention relates to an airbag device in which an airbag is inflated to protect a vehicle occupant in the event of a vehicle emergency, such as a collision. More particularly, the present invention relates to an airbag device in which the optimum conditions of the airbag are set so it can fully protect the occupant while being able to be mounted in a vehicle more efficiently.

An airbag is usually stored in a folded state in a recess disposed in the middle section of a steering wheel or within an instrument panel of a vehicle. In the event of a vehicle collision, the airbag is deployed and inflated into the vehicle interior by gas produced from an inflator to receive and retain an occupant.

In conventional airbags designed to have a large inflation volume, the size of the airbag is such that packaging the airbag in the airbag module for stowage in a vehicle is inefficient because the airbag takes up a large amount of space. Moreover, as the volume of the inflated airbag becomes larger a point is reached where the size of the inflated airbag impedes the escape of an occupant from the vehicle.

Another disadvantage of conventional airbags is that the airbag fabric is thick, or is made thick by the addition of films and coatings, such as silicone or neoprene. Such airbags take up a large amount of space when packaged. Additionally, such airbags cannot be firmly folded for packaging in the airbag module. As a result, the airbag begins to unfold as time passes. The use of heavy or thick material for airbag construction also increases the impact force imparted to the occupant when the airbag deploys and inflates.

Another disadvantage of conventional airbags is that airbag construction may be complex when multiple panels are used to form the airbag geometry. Such panels are joined by seams, such as welded seams, sewn seams, or woven seams. When the number of panels and seams increases, the volume of the airbag in a packaged state also increases, thereby taking up space in the vehicle.

### SUMMARY OF THE INVENTION

According to an embodiment of the present invention, an airbag device is provided. The airbag device is normally stored and is inflated and deployed toward an occupant in an event of an emergency. The ratio of the volume of the airbag in a packaged state and the volume of an airbag in an inflated state is less than approximately 1:30 (preferably less than approximately 1:80).

Thus, an airbag device is provided in which the optimum conditions of the airbag are set so the airbag can fully protect an occupant while being able to be mounted in a vehicle more efficiently.

Consequently, the force of restraining the occupant when the airbag is deployed is never too low nor too high, and the airbag can protect the occupant efficiently. In addition, a small volume of the airbag at the time of being packaged allows the extra space to be used for other purposes. For example, mounting of the airbag to a vehicle is facilitated, and use of larger fabric panels and smaller airbag mounting devices is made possible.

In the above airbag device, by limiting the airbag fabric to those made of yarns having a denier in the range of 200 to 500, the airbag fabric is finer and the volume of the airbag at the time of packaging can be made smaller and the volume of the airbag when inflated can be made larger. The packaged volume can also be kept down relative to the inflated volume by reducing or eliminating the amount of coating applied to the airbag material and by reducing the number of airbag panels and seams.

It is to be understood that both the foregoing general description and the following detailed description are exemplary and explanatory only and are not restrictive of the invention claimed.

### BRIEF DESCRIPTION OF THE DRAWINGS

These and other features, aspects, and advantages of the present invention will become apparent from the following description, appended claims, and the accompanying exemplary embodiments shown in the drawings, which are described briefly below.

FIG. 1 shows a side view of an airbag device in an inflated state according to an embodiment of the present invention.

FIG. 2 shows a side view of an airbag device in a packaged state according to an embodiment of the present invention.

FIG. 3 shows a perspective view of an airbag device in an inflated state according to an embodiment of the present invention.

FIG. 4 illustrates examples of ratios of packaged volume of an airbag of small size (in the range of 110 to 132 liters) to inflated volume.

### DETAILED DESCRIPTION

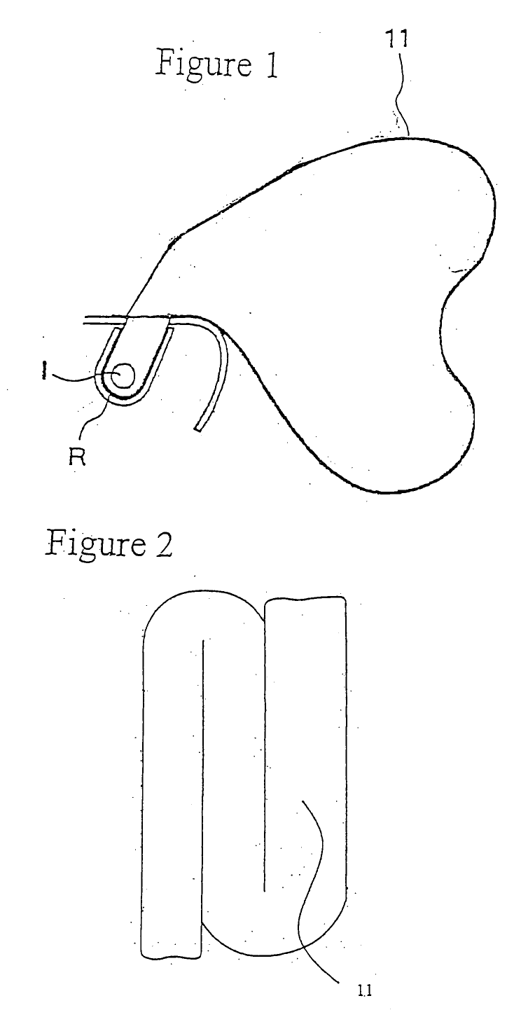

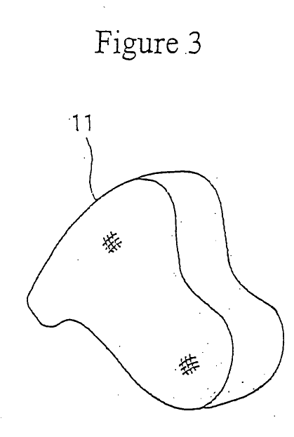

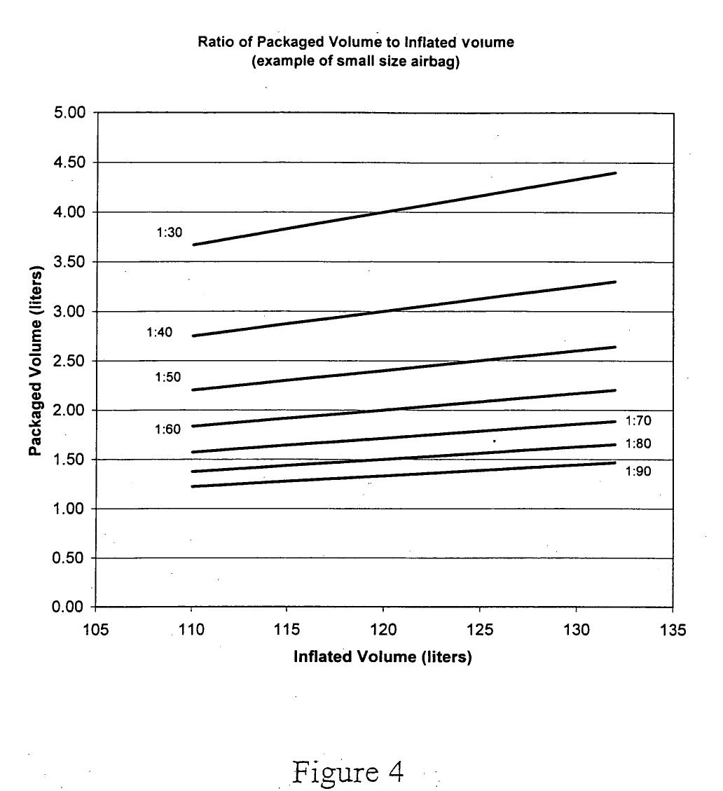

Embodiments according to the present invention will be described with reference to the attached drawings. FIG. 1 shows a side view of an airbag according to an embodiment of the present invention in an inflated state. FIG. 2 shows an airbag according to an embodiment of the present invention in a packaged state. FIG. 3 shows a perspective view of an airbag according to an embodiment of the present invention in an inflated state. As an example, FIG. 4 illustrates various ratios of the packaged volume of an airbag of small size (in the range of 110 to 132 liters) to the inflated volume.

According to an embodiment of the present invention, an airbag device is provided. The airbag device includes an airbag 11, a retainer R to which the airbag is mounted, an inflator I (gas generator) for deploying the airbag, and a module cover (not shown) covering the airbag. The airbag device may be disposed, for example, in a vehicle steering wheel or dashboard. For example, a driver side airbag may be disposed in a steering wheel, and a passenger side airbag may be disposed in a dashboard. The airbag 11 is normally stored in the airbag device in a folded or packaged state and is inflated and deployed toward an occupant in the event of an emergency, such as a vehicle collision. For example, a driver side airbag and a passenger side airbag may be deployed toward a front of the occupant. In order to economize vehicle space, it is desirable to package the airbag 11 so that it takes up a small volume of space. However, the inflated volume of the airbag 11 must be sufficiently large to adequately protect a vehicle occupant. Thus, there is a design tradeoff to be made between the packaged volume of the airbag 11 and the inflated volume of the airbag 11 so that vehicle space and occupant protection can be optimized. As shown in FIG. 4, the ratio of the volume of the airbag 11 in a packaged state and the volume of an airbag 11 in an inflated state may be less than 1:30, or less than approximately 1:40; or less than approximately 1:50, or less than 1:60, or less than approximately 1:70; or less than approximately 1:80.

When the packaged volume of the airbag 11 is more than 1/30 the inflated volume of the airbag 11, the size of the packaged airbag will become larger thereby taking up space. If the volume of the packaged airbag is made smaller, the volume of the airbag will also be smaller, as in a conventional airbag. Conversely, when the packaged volume of the airbag 11 is less than 1/90 the volume of the inflated airbag 11, the inflated airbag volume is much larger than the packaged airbag volume and an occupant will have difficulty trying to escape from the vehicle after the airbag inflates.

According to an embodiment of the present invention, the packaged volume of the airbag is directly related to the thickness of the material from which the airbag is constructed. If the material is thick, the airbag will have a larger packaged volume than if the material is thin. Additionally, airbags made of thicker materials are more difficult package because the airbag does not fold as easily as airbags made of thinner materials and has a tendency to unfold over time. Thus, according to this embodiment, an airbag fabric including yarns having a denier in the range of 200 to 500 is provided. Such an airbag is sufficiently thin so that the packaged volume is kept down. Moreover, such an airbag allows firm folds to be made, which prevents the airbag from starting to open as time passes. A thinner airbag fabric also reduces the impact of the airbag to an occupant. Thus, the impact of the airbag to an occupant will be made smaller, and the volume of the airbag when packaged can be kept down relative to the volume of the airbag when inflated.

According to an embodiment of the present invention, an airbag requiring a coating or film is provided. For example, a coating may be applied to an airbag fabric in order to impart low permeability characteristics to the airbag so that the airbag inflates rapidly and efficiently. Application of a coating or film to the airbag fabric increases the thickness of the airbag and results in an airbag having a larger packaged volume. According to this embodiment, in order to keep the thickness of the airbag down, the amount of coating or film applied to the airbag is about 150 grams or less per square meter of airbag material. Additionally, reducing the number of coatings applied to the airbag material will reduce airbag thickness. For example, the number of coatings can be limited to two. Thus, the packaged volume of the airbag is kept down relative to the inflated volume of the airbag because the thickness of the airbag is kept down.

According to an embodiment of the present invention, an airbag is provided that is constructed of a material with low permeability characteristics. Such an airbag does not require a coating so the thickness of the airbag can be kept down. For example, the airbag may be made of plastic. The airbag may also be made of an elastomer, such as resin, or of a fabric that can be tightly woven. Thus, according to this embodiment, the packaged volume of the airbag can be kept down relative to the inflated volume of the airbag.

According to an embodiment of the present invention, an airbag of simple construction is provided. The airbag is constructed such that the number of panels and the number of airbag seams are minimized. By reducing the number of panels that make up the airbag, the number of seams, such as sewn seams, welded seams, and woven seams, is also reduced. Reducing the number of seams results in an airbag made of fewer materials, which reduces the packaged volume of the airbag relative to the inflated volume.

Thus, according to an embodiment of the present invention, an airbag device is provided with conditions set at an optimum state and which can fully protect an occupant while being able to be efficiently mounted in a vehicle.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is defined in the following claims.

1. An airbag device for protecting an occupant of a vehicle, comprising:
an airbag module; and
an airbag disposed in the airbag module and configured to deploy and inflate in a direction toward an occupant in an event of a vehicle emergency;
wherein the airbag has a packaged volume when the airbag is disposed in the airbag module and an inflated volume when the airbag is inflated; and
wherein a ratio of the packaged volume to the inflated volume is less than approximately 1:30.

2. The airbag device of claim 1, wherein the ratio is less than approximately 1:40.

3. The airbag device of claim 2, wherein the ratio is less than approximately 1:50.

4. The airbag device of claim 3, wherein the ratio is less than approximately 1:60.

5. The airbag device of claim 4, wherein the ratio is less than approximately 1:70.

6. The airbag device of claim 5, wherein the ratio is less than approximately 1:80.

7. The airbag device of claim 6, wherein the ratio is less than approximately 1:90.

8. The airbag device of claim 1, wherein the airbag includes a fabric made of yarns having a denier of 200 to 500.

9. The airbag device of claim 1, wherein the airbag includes a fabric made of yarns having a denier of 200 to 300.

10. The airbag device of claim 1, wherein the airbag includes a fabric made of yarns having a denier of 200 to 400.

11. The airbag device of claim 1, wherein the airbag includes a fabric made of yarns having a denier of 300 to 400.

12. The airbag device of claim 1, wherein the airbag includes a fabric made of yarns having a denier of 300 to 500.

13. The airbag device of claim 1, wherein the airbag includes a fabric made of yarns having a denier of 400 to 500.

14. The airbag device of claim 1, wherein the airbag includes a low permeability material.

15. The airbag device of claim 14, wherein the low permeability material comprises plastic.

16. The airbag device of claim 14, wherein low permeability material comprises an elastomer.

17. The airbag device of claim 16, wherein the elastomer is resin.

18. The airbag device of claim 14, wherein the low permeability material comprises tightly woven yarns.

19. The airbag device of claim 1, wherein the airbag includes a coating.

20. The airbag device of claim 18, wherein the coating is disposed on the airbag such that the amount of coating to airbag surface area does not exceed 150 grams ounce of coating to 1 square meter of airbag surface area.

21. The airbag device of claim 18, wherein the airbag includes only one layer of coating.

22. The airbag device of claim 18, wherein the airbag includes only two layers of coating.

23. The airbag device of claim 1, wherein the airbag includes only a first panel and a second panel.

24. The airbag device of claim 23, wherein the first panel and the second panel are joined at a periphery of the first panel and a periphery of the second panel.

25. The airbag device of claim 1, wherein the airbag is a driver side airbag.

26. The airbag device of claim 1, wherein the airbag is a passenger side airbag

27. The airbag device of claim 1, wherein the airbag is configured to deploy toward a front portion of the occupant.

28. An airbag device for protecting an occupant of a vehicle, comprising:
an airbag module; and
an airbag disposed in the airbag module to occupy a first volume and configured to deploy and inflate in a direction toward an occupant in an event of a vehicle emergency to occupy a second volume;
wherein the airbag has a first volume and a second volume; and
wherein the second volume is at least approximately 30 times the first volume.

29. The airbag device of claim 28, wherein the second volume is at least approximately 60 times the first volume.

30. The airbag device of claim 28, wherein the second volume is at least approximately 60 times the first volume.

31. The airbag device of claim 28, wherein the second volume is at least approximately 70 times the first volume.

32. The airbag device of claim 28, wherein the second volume is at least approximately 80 times the first volume.

33. The airbag device of claim 28, wherein the second volume is at least approximately 90 times the first volume.

34. The airbag device of claim 28, wherein the airbag includes a fabric made of yarns having a denier of 200 to 500.
